(19) United States
(12) Patent Application Publication
(10) Pub. No.: US 2012/0130582 A1
(43) Pub. Date: May 24, 2012

(54) MACHINE CONTROL SYSTEM IMPLEMENTING INTENTION MAPPING

(76) Inventor: Ramadev Burigsay HUKKERI, Pittsburgh, PA (US)

(21) Appl. No.: 12/951,848

(22) Filed: Nov. 22, 2010

(51) Int. Cl. G05D 1/02; B60W 10/18; B60W 10/20; G06F 7/00

(52) U.S. Cl. 701/25; 701/50

(57) ABSTRACT

A control system for a first machine operating at a worksite is disclosed. The control system may have at least a first module configured to generate a signal indicative of a current position and a characteristic of a second machine at the worksite in a vicinity of the first machine, and a controller in communication with the at least a first module. The controller may be configured to determine a probability value, based on the characteristic of the second machine, of one of a plurality of known locations at the worksite being a current destination for the second machine. The controller may also be configured to make a prediction of an intended travel path for the second machine based on the current position of the second machine and the probability value. The controller may further be configured to determine a travel response for the first machine based on the prediction and a current travel path of the first machine.

### TECHNICAL FIELD

The present disclosure relates generally to a machine control system, and more particularly, to a machine control system implementing intention mapping.

### BACKGROUND

Mobile machines such as haul trucks, excavators, motor graders, backhoes, water trucks, and other large equipment are utilized at a common worksite to accomplish a variety of tasks. At these worksites, because of the size of the machines, lack of visibility, slow response time, and difficulty of operation, operators must be keenly aware of their surroundings. Specifically, each operator must be aware of road conditions, facilities, roadway obstructions, and other mobile machines in the same vicinity. Based on the speed and travel path of a particular machine, and its size and performance profile, the operator of the machine must respond differently to each encountered obstacle in order to avoid collision and damage to the machine. In some situations, there may be insufficient warning for the operator to adequately maneuver the machine away from damaging encounters.

One way to help minimize the likelihood of damaging encounters or the severity of unavoidable encounters is disclosed in US Patent Application Publication No. 2010/0036578 (the '578 publication) by Taguchi et al. that published on Feb. 11, 2010. Specifically, the '578 publication discloses a control apparatus that controls an automatic operation of a host vehicle based on predicted behavior of a nearby vehicle. The control apparatus predicts the behavior of the nearby vehicle by calculating history information concerning the position and operation of the nearby vehicle. The history information includes a relative position between the host vehicle and the nearby vehicle, the speed of the nearby vehicle, the acceleration of the nearby vehicle, the yaw-angle of the nearby vehicle, and the road line shape. This information is passed through a driver model, which estimates driver tendencies and a cruising manner of the nearby vehicle. Based on the driver tendencies and cruising manner, a behavior prediction for the near future can then be formed. A cruise control plan for the host vehicle is subsequently prepared and implemented based on the behavior prediction for the nearby vehicle.

Although the control apparatus of the '578 publication may help to avoid collisions between nearby vehicles, it may be limited and less than optimal. In particular, the control apparatus may be limited to only those situations where two vehicles are operating near each other for extended periods of time such that enough historical information can be collected. In addition, the control apparatus may not consider machine-specific or worksite information that could improve behavior prediction and machine control.

The disclosed machine control system is directed to overcoming one or more of the problems set forth above and/or other problems of the prior art.

### SUMMARY

In one aspect, the present disclosure is directed to a control system for a first machine operating at a worksite. The control system may include at least a first module configured to generate a signal indicative of a current position and a characteristic of a second machine at the worksite in a vicinity of the first machine, and a controller in communication with the at least a first module. The controller may be configured to determine a probability value, based on the characteristic of the second machine, of one of a plurality of known locations at the worksite being a current destination for the second machine. The controller may also be configured to make a prediction of an intended travel path for the second machine based on the current position of the second machine and the probability value. The controller may further be configured to determine a travel response for the first machine based on the prediction and a current travel path of the first machine.

In another aspect, the present disclosure is directed to a computer readable medium for use with a machine control system, the computer readable medium having computer executable instructions for performing a method of control for a first machine at a worksite. The method may include determining a current position and a characteristic of a second machine at the worksite in a vicinity of the first machine. The method may further include determining a probability value, based on the characteristic of the second machine, of one of a plurality of known locations at the worksite being a current destination for the second machine. The method may also include making a prediction of an intended travel path for the second machine based on the current position and the probability value, and determining a travel response for the first machine based on the prediction and a current travel path of the first machine.

### BRIEF DESCRIPTION OF THE DRAWINGS

FIG. 1 is a schematic illustration of an exemplary disclosed control system for a machine operating at a common worksite.

### DETAILED DESCRIPTION

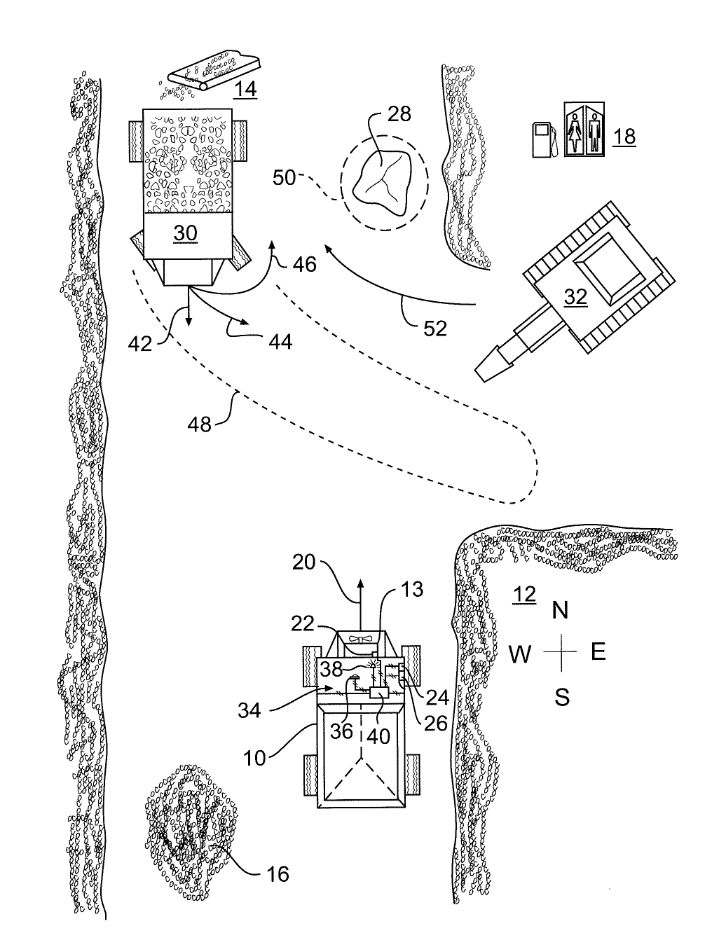

FIG. 1 illustrates an exemplary mobile machine 10 performing a predetermined task at a worksite 12. Worksite 12 may include, for example, a mine site, a landfill, a quarry, a construction site, a road worksite, or any other type of worksite. The predetermined task may be associated with any activity appropriate at worksite 12, and may require machine 10 to generally traverse worksite 12 between different destinations. The destinations may include, for example, an excavation location 14, a dump location 16, and a service location 18.

Machine 10 may embody any type of driven machine that may be used at worksite 12. For example, machine 10 may embody a haul truck, an excavator, a motor grader, a backhoe, or a water truck. Machine 10 may generally be propelled by a power source 13, such as a motor or an engine, to follow a travel path 20 in, for example, a northerly direction. Although not shown, the movement of machine 10 along travel path 20 may be at least partially determined by an acceleration control 22, a braking control 24, and a direction control 26. Acceleration control 22 of machine 10 may include, for example, an acceleration pedal and/or a deceleration pedal configured to adjust operation of power source 13 (e.g., fueling) and/or an associated transmission (e.g., selected gear ratio) to affect acceleration and/or deceleration of machine 10. Braking control 24 of machine 10 may include, for example, a brake pedal connected to a braking element (not shown) used to slow or stop machine 10. Direction control 26 of machine 10 may include, for example, a steering wheel, a joystick, or another direction control known in the art connected to a steering element (not shown) used to change the direction of machine 10. It is contemplated that machine 10 may include any number of other components and features such as, for example, a traction device, an operator cabin, a work tool, or any other component or feature known in the art. It is also contemplated that machine 10 may embody an autonomous machine configured to autonomously traverse worksite 12, a manned machine configured to traverse worksite 12 under the control of an operator, or a hybrid machine configured to perform some functions autonomously and other functions under the control of an operator.

As machine 10 traverses worksite 12, it may encounter any number of objects that make movement of machine 10 difficult, hazardous, or even impossible. The objects at worksite 12 may include, for example, a natural object 28 such as a boulder, a pothole, or a fallen tree. The objects at worksite 12 may further include man-made and/or mobile objects such as other machines 30, 32. It is contemplated that machines 30, 32 may embody any type of mobile machine that traverses worksite 12, and may be autonomously or manually controlled. It is further contemplated that machine 10 may be regarded as an object with respect to the movement of machines 30, 32.

In order to facilitate collision avoidance of machine 10 with the objects at worksite 12, a control system 34 included onboard machine 10 may selectively implement intention mapping of the objects at worksite 12. In particular, control system 34 may generally include components that cooperate to receive and determine information about the objects of worksite 12 and about machine 10 and electronically map out spaces at worksite 12 of intended travel for the objects and machine 10. The resulting intention map may include, for example, current locations of machine 10 and the objects at worksite 12, locations of destinations 14-18, and predicted travel paths between the current locations and the destinations. The locations and predicted travel paths may be represented by, for example, site coordinates and/or zones at worksite 12. Control system 34 may generate the intention map and store it in a memory as, for example, a 2-dimensional or 3-dimensional grid, or in any other manner known in the art. Thus, the intention map, including machine 10, the objects at worksite 12, destinations 14-18, and the predicted travel paths, may be represented as data in the memory of control system 34. It is contemplated that the intention map may alternatively be embodied as a database accessible by control system 34, if desired. The components of control system 34 may include, among other things, a communications module 36, a position detection module 38, and a controller 40.

Communications module 36 may be configured to monitor characteristics of machine 10 and communicate these characteristics to other machines 30, 32 also operating at worksite 12 and to controller 40. The characteristics may include, among other things, a machine heading, speed, acceleration, and/or steering angle; a machine type, size, and/or identification; a loading condition (e.g., empty, partly loaded, fully loaded); an operating level (e.g., rated, derated, or percent derated); and a time in service relative to an operator shift period or scheduled maintenance. It is contemplated that similar communications modules (not shown) may be included at or within other objects of worksite 12 (e.g., within other machines 30, 32) to monitor the characteristics thereof and communicate them to communications module 36 onboard machine 10. It is further contemplated that communications module 36 located onboard machine 10 may be configured to remotely monitor the characteristics of machines 30, 32. For the purposes of this disclosure, communications module 36 may be considered hardware and software, separate or in combination, that function to monitor and communicate characteristic information. For example, communications module 36 may include a plurality of sensors (not shown) such as a load sensor, a position sensor, a direction sensor, a velocity sensor, an acceleration sensor, a fueling sensor, a brake sensor, a steering angle sensor, and other known sensors; a transceiver (not shown) programmed to transmit sensed information to other machines 30, 32; and a receiver (not shown) programmed to receive similar information from other machines 30, 32.

Position detection module 38 may be configured to determine position information relating to a location of machine 10 at worksite 12 and/or of a location of other machines 30, 32 operating at worksite 12 in a vicinity of machine 10 (i.e., within a sensing and/or communications distance of communications and/or position detection modules 36, 38). In one embodiment, position detection module 38 may embody a global positioning system (GPS) device configured to communicate with multiple satellites orbiting earth to determine a global position of machine 10 and generate corresponding position information. In another embodiment, position detection module 38 may include a local positioning sensor, for example, a lidar sensor, a radar sensor, or a camera configured to detect a location and/or identity of other machines 30, 32 and objects 28 from a known position onboard machine 10. The position information generated by position detection module 38 may be directed to controller 40 and, in some instances, offboard to other machines 30, 32 via communications module 36.

Controller 40 may include means for receiving characteristic and position information from communications module 36 and position detection module 38, for mapping out intended travel spaces of the objects at worksite 12 based on the information, and for implementing evasive responses based on the intended travel spaces. For example, controller 40 may include a memory, a secondary storage device, a clock, and one or more processors that cooperate to accomplish a task consistent with the present disclosure. Numerous commercially available microprocessors can be configured to perform the functions of controller 40. It should be appreciated that controller 40 could readily embody a computer system capable of controlling numerous other functions. Various other known circuits may be associated with controller 40, including signal-conditioning circuitry, communication circuitry, and other appropriate circuitry. It should also be appreciated that controller 40 may include one or more of an application-specific integrated circuit (ASIC), a field-programmable gate array (FPGA), a computer system, and a logic circuit configured to allow controller 40 to function in accordance with the present disclosure. Thus, the memory of controller 40 may embody, for example, the flash memory of an ASIC, flip-flops in an FPGA, the random access memory of a computer system, or a memory contained in a logic circuit. Controller 40 may be further communicatively coupled with an external computer system, instead of or in addition to including a computer system.

Controller 40, located onboard machine 10, may be configured to execute instructions stored on computer readable medium to perform a method of machine control. Specifically, based on a current position of other machines 30, 32 provided by communications module 36 and/or by position detection module 38, and the known possible destinations 14-18 at worksite 12, controller 40 may be configured to generate a number of potential travel paths that each other machine 30, 32 could take at a given point in time. For example, based on the current position of machine 30 shown in FIG. 1 and based on the positions of excavation location 14, dump location 16, and service location 18, controller 40 may determine that three different potential travel paths for machine 30 exist. A first potential travel path 42 may include movement of machine 30 from its current location to dump location 16. A second potential travel path 44 may include movement of machine 30 from its current location to service location 18. A third potential travel path 46 may include movement of machine 30 from its current location to excavation location 14. It is contemplated that other potential travel paths are also possible.

Controller 40 may be configured to predict which of the potential travel paths will likely be taken by machines 30, 32 based on characteristics of machines 30, 32. Specifically based on the machine heading, speed, acceleration, and/or steering angle; the machine type, size, and/or identification; the loading condition; the operating level; and/or the time in service relative to an operator shift period or scheduled maintenance, as received or determined via communications module 36, controller 40 may be able to determine a probability of locations 14-18 being a current destination of machines 30, 32 and assign corresponding probability values to each location. Controller 40 may then be configured to exclude one or more of the potential travel paths and/or focus in on one or more others of the potential travel paths based on the probability value. Returning to the previous example used above, controller 40 may receive characteristic information indicating that machine 30 is a fully loaded haul truck heading south and that the operator of machine 30 is nearing a shift-end. Based on this information and one or more maps stored in memory relating object characteristics to possible destinations, controller 40 may determine a low probability of machine 30 reversing its travel direction and moving from its current location to excavation location 14 for additional loading and, accordingly, assign a low probability value to excavation location 14. Instead, controller 40 may conclude that it is more probable that machine 30 is either following travel path 42 to dump location 16 where machine 30 will dump its load, or travel path 44 to service location 18 where the operator may end the shift. Accordingly, controller 40 may assign higher probability values to dump location 16 and service location 18. Based on additional characteristic information relating to machine steering angle and deceleration, controller 40 may further narrow the list of probable travel paths to travel path 44 and, accordingly, assign a highest probability value to service location 18.

Based on the most probable or a number of probable travel paths (i.e., the travel paths associated with the locations having the highest probability value(s)) determined for machines 30, 32, controller 40 may generate the intention map. In particular, controller 40 may determine a space or zone 48 surrounding the probable travel path that would be occupied should the corresponding machine 30, 32 actually follow that path. For example, if machine 30 were to actually follow travel path 44, a space 48 from the current location of machine 30 to service location 18 would be occupied by machine 30 at some point in time. Accordingly, controller 40 may mark this space as a collision-risk area on the intention map of worksite 12.

The size and shape of space 48 may be based at least in part on characteristics of the object for which space 48 is generated. For example, space 48 may have a size and a curvature based on a size of machine 30 and a corresponding known turning radius. Similarly, the size and/or shape of space 48 may be based on a speed of the detected object, a loaded condition of the object, and/or a potential severity of a collision with the object. Other ways of generating the shape and/or size of space 48 are also considered.

Controller 40 may implement a travel response based on the intention map (i.e., based on the space that would be occupied by other machines 30, 32 should they follow a determined most probable travel path) and characteristics of machine 10, such that collision with the objects at worksite 12 may be avoided. The travel response may include, among other things, visually and/or audibly alerting an operator of machine 10 of the probable travel paths of other machines 30, 32 and associated collision risks, providing a recommendation to the operator (e.g., slow down, stop, speed up, turn, etc.), and/or autonomously controlling machine 10 (via acceleration, braking, and directional controls 22-26) to avoid intersection with the potentially occupied space.

It is contemplated that the travel response may be based at least partially on characteristics of machine 10 such as a type, size, loading condition, turning radius, stopping distance, etc. For example, if machine 10 is a large and fully-loaded haul truck with a long stopping distance, the recommendation or autonomous control may focus more on steering than on stopping.

When providing the warning and recommendation or when autonomously controlling machine 10, controller 40 may also be configured to consider the terrain at worksite 12 and the location of immobile objects, for example natural object 28. Further, if an object at worksite 12, for example natural object 28, is unidentifiable by communications module 36, controller 40 may be configured to generate a safety zone 50 about object 28 that should be avoided during the travel response, a size and/or location of safety zone 50 being based on any information that is known or detected (e.g., size, heading, etc.).

It is contemplated that controller 40 may simultaneously consider multiple potential travel paths when determining and/or implementing the travel response. For example, if it is determined that machine 30 is most likely to follow travel path 42 while at the same time machine 32 is determined most likely to follow a travel path 52, a selection of available travel responses may be reduced. That is, machine 10, in this situation, may not have the option to steer away and avoid travel path 52 of machine 32, as the steering away might cause machine 10 to intersect with travel path 42. In this situation, the combined likely travel paths and associated spaces 48 may limit the travel options of controller 40 to only slowing or stopping machine 10.

### INDUSTRIAL APPLICABILITY

The disclosed control system may be applicable to any machine application where improved collision avoidance is desired. Although applicable to both manned and unmanned machines, the disclosed control system may be particularly applicable to unmanned machines where autonomous control of the machines may be directly affected by intention mapping.

The disclosed control system may possess several different advantages. For example, the disclosed system may be used on a host machine to predict the likely travel path of another nearby machine without requiring an extended period of historical data collection. This ability may allow for quicker predictions and travel responses that enhance worksite safety and control. In addition, because the disclosed control system may consider machine-specific and worksite information, an accuracy of the resulting predictions may be high.

It will be apparent to those skilled in the art that various modifications and variations can be made to the control system of the present disclosure without departing from the scope of the disclosure. Other embodiments will be apparent to those skilled in the art from consideration of the specification and practice of the control system disclosed herein. For example, although the characteristic information of objects at worksite 12 are described as being sensed or communicated, it is contemplated that the characteristic information may alternatively be determined based on sensed and known parameters. Specifically, based on a sensed heading, speed, acceleration and/or size of an object, controller 40 may be configured to determine a corresponding type of machine or other characteristic. It is intended that the specification and examples be considered as exemplary only, with a true scope of the disclosure being indicated by the following claims and their equivalents.

What is claimed is:

1. A control system for a first machine operating at a worksite, comprising:
at least a first module configured to generate a signal indicative of a current position and a characteristic of a second machine at the worksite in a vicinity of the first machine; and
a controller in communication with the at least a first module, the controller being configured to:
determine a probability value, based on the characteristic of the second machine, of one of a plurality of known locations at the worksite being a current destination for the second machine;
make a prediction of an intended travel path for the second machine based on the current position of the second machine and the probability value; and
determine a travel response for the first machine based on the prediction and a current travel path of the first machine.

2. The control system of claim 1, wherein the characteristic is at least one of a heading, a speed, an acceleration, and a steering angle of the second machine.

3. The control system of claim 1, wherein the characteristic is at least one of a type, a loading condition, and a size of the second machine.

4. The control system of claim 1, wherein the characteristic is at least one of an operating level of the second machine and a time in service of the second machine relative to an operator shift period.

5. The control system of claim 1, wherein:
the controller is configured to generate a safety zone about the intended travel path of the second machine; and
the travel response is associated with the first machine avoiding the safety zone.

6. The control system of claim 5, wherein the safety zone has a size and a shape based at least in part on the characteristic of the second machine.

7. The control system of claim 1, wherein the at least a first module includes a communications module configured to receive at least one of the current position and the characteristic of the second machine from the second machine.

8. The control system of claim 1, wherein the at least a first module includes a sensor configured to detect a position of the second machine relative to the first machine.

9. The control system of claim 1, wherein the controller includes a map stored in memory relating the characteristic of the second machine to the plurality of known destinations.

10. The control system of claim 1, wherein the travel response includes at least one of a warning and a recommendation provided to an operator of the first machine.

11. The control system of claim 1, wherein the travel response includes autonomous control of the first machine to avoid collision with the second machine.

12. The control system of claim 1, wherein the travel response is based on at least one of a type, a size, and a loading condition of the first machine.

13. A computer readable medium for use with a machine control system, the computer readable medium having computer executable instructions for performing a method of control for a first machine at a worksite, the method comprising:
determining a current position and a characteristic of second machine at the worksite in a vicinity of the first machine;
determining a probability value, based on the characteristic of the second machine, of one of a plurality of known locations at the worksite being a current destination for the second machine;
making a prediction of an intended travel path for the second machine based on the current position of the second machine and the probability value; and
determining a travel response for the first machine based on the prediction and a current travel path of the first machine.

14. The computer readable medium of claim 13, wherein the characteristic is at least one of a heading, a speed, an acceleration, and a steering angle of the second machine.

15. The computer readable medium of claim 13, wherein the characteristic is at least one of a type, a loading condition, and a size of the second machine.

16. The computer readable medium of claim 13, wherein:
the method further includes determining a safety zone about the intended travel path of the second machine; and
the travel response is associated with the first machine avoiding the safety zone.

17. The computer readable medium of claim 13, wherein determining a current position and a characteristic of the second machine includes receiving the current position and characteristic via communications from the second machine.

18. The computer readable medium of claim 13, wherein determining a current position and a characteristic of the second machine includes remotely detecting the current position and characteristic.

19. The computer readable medium of claim 13, wherein the travel response includes at least one of a warning provided to an operator of the first machine, a recommendation provided to the operator of the first machine, and autonomous control of the first machine.

20. A first machine configured to operate at a worksite, the first machine comprising:
an acceleration control;
a braking control;
a direction control;
a communications module configured to determine a characteristic of a second machine at the worksite in a vicinity of the first machine, the characteristic being related to a type of the second machine, a size of the second machine, a heading of the second machine, or a loading condition of the second machine;
a position detection module configured to detect a position of the second machine relative to the first machine; and
a controller in communication with the acceleration control, the braking control, the direction control, the communications module, and the position detection module, the controller being configured to:
determine a probability value, based on the characteristic of the second machine, of one of a plurality of known locations at the worksite being a current destination for the second machine;
make a prediction of an intended travel path for the second machine based on the current position of the second machine and the probability value;
determine a safety zone positioned about the intended travel path for the second machine, the safety zone having a size and a shape based at least partially on the characteristic of the second machine; and
autonomously control the first machine via the acceleration, braking, and direction controls based on the prediction and a current travel path of the first machine to avoid the safety zone.
